(19) United States
(12) Patent Application Publication
(10) Pub. No.: US 2015/0328767 A1
(43) Pub. Date: Nov. 19, 2015

(54) Snowmobile Stand Systems

(71) Applicant: Tracy Sikes, Mead, WA (US)

(72) Inventor: Tracy Sikes, Mead, WA (US)

(21) Appl. No.: 14/280,359

(22) Filed: May 16, 2014

(51) Int. Cl. B25H 1/00; B66F 7/02

(52) U.S. Cl. CPC B25H 1/0007; B66F 7/02

(57) ABSTRACT

A snowmobile stand system includes a lever mechanism pivotably coupled to at least one pivot coupled to at least one side support. The lever mechanism including a gripping portion that moves from a first position where the gripping portion is arranged in front of the snowmobile stand system to a second position where the gripping portion is arranged behind the snowmobile stand system. When actuated, the lever mechanism causes at least a rear portion of a snowmobile to be raised a distance from a bottom of the snowmobile stand. The snowmobile stand system includes a lifting member movable to an unlatched position for positioning under the rear portion of the snowmobile between a track of the snowmobile and the received rear portion of the snowmobile, and is movable to a latched position to lift the rear portion of the snowmobile.

### BACKGROUND

Snowmobile stands exist for lifting a snowmobile off of the ground to service a track of the snowmobile or store the snowmobile for extended periods of time. Existing stands are typically too big or too inconvenient to use in a confined space. For example, existing stands are extremely difficult to use in a snowmobile trailer or when snowmobiles are parked end to end. Moreover, existing stands may interfere with a snow flap and cause damage to the snow flap, and a damaged snow flap can result in inadequate cooling of snowmobiles.

Accordingly there remains a need in the art for improved snowmobile stands that are compact, easy to use, and do not damage a snowmobile.

### SUMMARY

This summary is provided to introduce simplified concepts of snowmobiles stands, which are further described below in the Detailed Description. This summary is not intended to identify essential features of the claimed subject matter, nor is it intended for use in determining the scope of the claimed subject matter. Snowmobile stands according to this disclosure are configured to lift a track off of a surface to service a track and/or prevent paddles of the track from being damaged when parked. The snowmobile stands enable a user to lift a track of a snowmobile in confined spaces.

In one example, a snowmobile stand includes a support member including a first side support and a second side support. The first and second side supports are spaced a distance apart to receive at least a rear portion of a snowmobile between the first and second side supports. A lifting member is disposed between and coupled to the first and second side supports. The lifting member includes a coupling member selectively movable between a latched position and an unlatched position. The coupling member is movable to the unlatched position for positioning under the received rear portion of the snowmobile between a track of the snowmobile and the received rear portion of the snowmobile, and is movable to the latched position to lift the received rear portion of the snowmobile.

In another example, a snowmobile stand includes a support member including a first side support separated a distance from a second side support. Each of the first and second side supports has symmetrically facing surfaces that face each other. The symmetrically facing surfaces are separated by the distance and arranged to receive at least a rear portion of a snowmobile between the symmetrically facing surfaces. When the lever mechanism is actuated, the lever mechanism causes at least the rear portion of the snowmobile to be raised a distance from the bottom of the support member, between the symmetrically facing surfaces of the first and second side supports.

In another example, a snowmobile lifting system includes a support member having a top opposite a bottom, and including a lifting mechanism. The lifting mechanism includes a lever coupled to the support member by at least one pivot. The lifting mechanism further includes a gripping portion coupled to a first end of the lever, and a lifting member to engage at least a portion of a snowmobile. The lever is pivotable about the pivot, responsive to a displacement of the gripping portion from a first position where the gripping portion is arranged on a first side of the support member to a second position where the gripping portion is arranged on a second side of the support member opposite the first side. And, the lifting member raises at least a portion of the snowmobile a distance from the bottom of the support member when the gripping portion is displaced from the first position to the second position.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a perspective view of an example snowmobile stand.

FIG. 2 illustrates a side view of the example snowmobile stand shown in FIG. 1 including a lever mechanism having a gripping portion displaceable between a first position and a second position.

FIG. 3 illustrates a perspective view of the example snowmobile stand shown in FIG. 1 with a snowmobile in a lifted position.

FIG. 4 illustrates a back view of the example snowmobile stand shown in FIG. 1 having a coupling member selectively movable between a latched position and an unlatched position.

### DETAILED DESCRIPTION

### Overview

This disclosure is directed to snowmobile stands and systems that lift a received rear portion of a snowmobile in confined spaces to service and/or prevent damage of a track of the snowmobile when the snowmobile is parked. For example, the snowmobile stands may include a support member including first and second side supports arranged to receive at least a portion of a snowmobile between the first and second side supports. The support member may include a lifting member disposed between the first and second side supports, and arranged to raise a received rear portion (e.g., a bumper, a frame, a track tunnel, and/or a track) of a snowmobile a distance from a bottom of the support member. In some examples, the lifting may lift the track completely off the ground floor, trailer, or other supporting surface. For example, the lifting member may include a coupling member selectively movable between a latched position and an unlatched position. The coupling member may be movable to the unlatched position for positioning under the received rear portion of the snowmobile between a track of the snowmobile and the received rear portion of the snowmobile and movable to the latched position in preparation to lift the received rear portion of the snowmobile.

The snowmobile stands may include first and second side supports having symmetrically facing surfaces separated by a distance and arranged to receive at least a rear portion of a snowmobile between the symmetrically facing surfaces. For example, the first and second side supports may each have a surface arranged along an inside portion of the first and second side supports that are similar in size, shape, and face each other along the inside portions of the first and second side supports. The first and second side supports may have first and second pivots pivotably coupled on the symmetrically facing surfaces. A lever mechanism may be pivotably coupled to the first and second pivots and arranged to raise the rear portion of the snowmobile between the symmetrically facing surfaces of the first and second side supports.

The snowmobile stands may include a lifting mechanism. The lifting mechanism may include the lever coupled to the support member by at least one of the pivots, a gripping portion coupled to a first end of the lever, and a lifting member coupled to a second end of the lever. The lever may be pivotable about the pivot, responsive to a displacement of the gripping portion, and responsive to the displacement of the gripping portion from a first position to a second position, the lever may cause the lifting member to be raised a distance from the bottom of the support member.

These and other aspects of the snowmobile stands will be discussed below with reference to the figures.

### Illustrative Snowmobile Stands

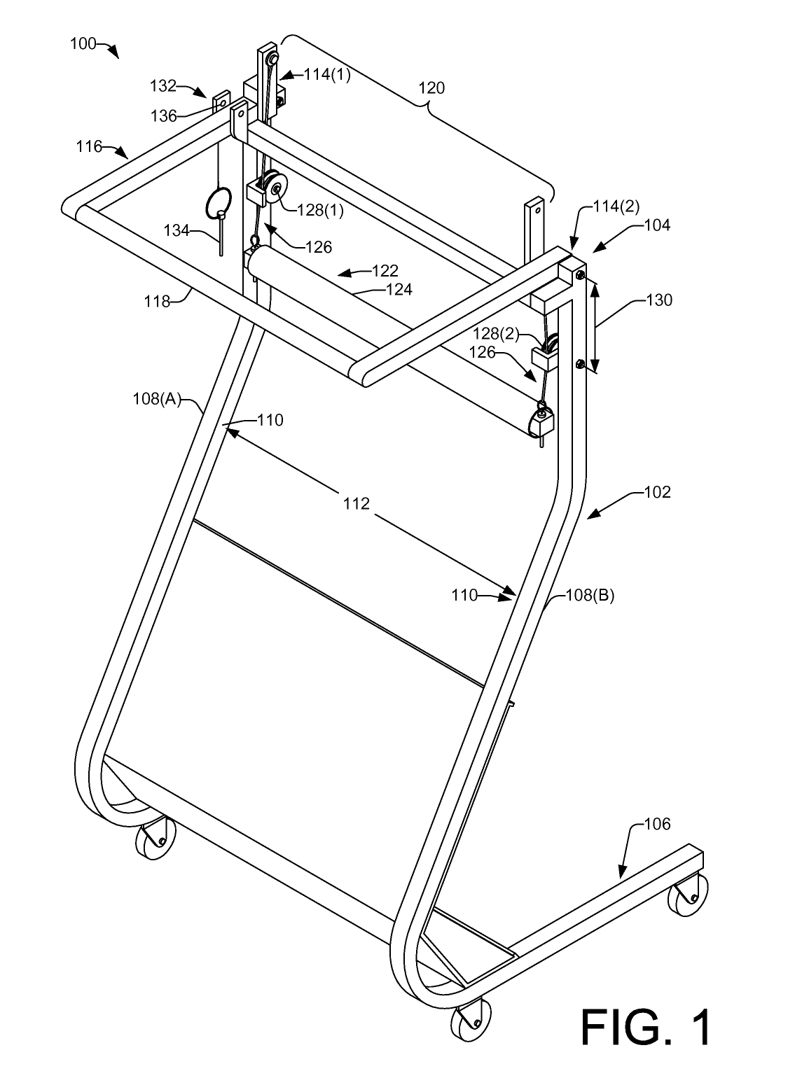

FIG. 1 illustrates a perspective view of an example snowmobile stand 100. The snowmobile stand 100 may include a support member 102 having a top 104 opposite a bottom 106. The bottom 106 of the support member 102 may rest on a surface (e.g., a floor of a snowmobile trailer, a floor of a shop, the ground), and the top 104 of the support member 102 may be arranged a distance above the bottom 106 and provide for lifting a portion of a snowmobile up away from the bottom 106 of the support member 102. One or more wheels or castors may be fixed to the bottom 106 of the support member 102. The wheels or castors may provide mobility in a shop, a garage, or in a trailer, etc. When provided, the castors may be uni-directional and/or multidirectional.

The support member 102 may include first and second side supports 108(1) and 108(2). Each of the first and second side supports 108(1) and 108(2) may have a symmetrically facing surface 110. The first and second side supports 108(1) and 108(2) may be separated by a distance 112 to receive at least a rear portion of a snowmobile. For example, the symmetrically facing surfaces 110 of the first and second side supports 108(1) and 108(2) may be separated by a distance 112 of at least about 12 inches up to about 32 inches to receive at least a rear portion of a snowmobile between the symmetrically facing surfaces 110. In another example, the first and second side supports 108(1) and 108(2) may be separated by a distance 112 of at about 22 inches.

The snowmobile stand 100 may include first and second pivots 114(1) and 114(2). The first pivot 114(1) may be pivotably coupled on the symmetrically facing surface 110 of the first side support 108(1) at the top 104 of the support member 102, and the second pivot 114(2) may be pivotably coupled on the symmetrically facing surface 110 of the second side support 108(2) at the top 104 of the support member 102.

The snowmobile stand 100 may include a lever mechanism 116 pivotably coupled to the first and second pivots 114(1) and 114(2) pivotably coupled on the symmetrically facing surfaces 110 of the first and second side supports 108(1) and 108(2). The lever mechanism 116 may include a gripping portion 118 arranged opposite the first and second pivots 114(1) and 114(2) pivotably coupled in the first and second side supports 108(1) and 108(2). When actuated, the lever mechanism 116 may cause at least a rear portion of the snowmobile to be raised a distance from the bottom 106 of the support member 102, between the symmetrically facing surfaces 110 of the first and second side supports 108(1) and 108(2).

The snowmobile stand 100 may include a lifting member 120 disposed between and coupled to the first and second side supports 108(1) and 108(2) to engage at least a portion of a snowmobile. For example, the coupling member 122 may removeably couple under the received rear portion of the snowmobile between a track of the snowmobile and the received rear portion of the snowmobile to raise the received rear portion of the snowmobile a distance from the bottom 106 of the support member 102, between the symmetrically facing surfaces 110 of the first and second side supports 108(1) and 108(2). The coupling member 122 may be coupled to an end of the lever mechanism 116 opposite the gripping portion 118. In one example, the lifting member 120 may include a coupling member 122 disposed between the symmetrically facing surfaces 110 of the first and second side supports 108(1) and 108(2). The coupling member 122 may include a guard 124. For example, the guard 124 may completely or partially cover the coupling member 122 and may comprise a protective material to prevent damaging graphics of a snowmobile. For example, the guard 124 may comprise a plastic tube covering the coupling member, an adhesive liner covering the coupling member, a foam pad covering the coupling member, etc. to keep from damaging the snowmobile. The coupling member 122 may be movable from a released position to a latch position in preparation to lift the received rear portion of the snowmobile. A linkage 126 may couple the coupling member 122 to the lever mechanism 116. The linkage 126 may comprise one or more flexible cables, rigid links, chains, belts, etc. In one example, the linkage 126 may comprise ⅛ inch steel cables, each about 11.5 inches long from the lever mechanism 116 to the coupling member 122. The lever mechanism 116 may couple the lifting member 120 to the first and second side supports 108(1) and 108(2) and cause the coupling member 122 to lift the received rear portion of the snowmobile.

FIG. 1 illustrates first and second guides 128(1) and 128(2) fixed to the first and second side supports 108(1) and 108(2). The first guide 128(1) may be fixed to the symmetrically facing surface 110 of the first side support 108(1) below the first pivot 114(1) pivotably coupled on the symmetrically facing surface 110 of the first side support 108(1) at the top 104 of the support member 102. The second guide 128(2) may be fixed to the symmetrically facing surface 110 of the second side support 108(2) below the second pivot 114(2) pivotably coupled on the symmetrically facing surface 110 of the second side support 108(2) at the top 104 of the support member 102. The first and second guides 128(1) and 128(2) may guide the lifting member 120 to lift the received rear portion of the snowmobile a distance from the bottom 106 of the support member 102 straight up, between the symmetrically facing surfaces 110 of the first and second side supports 108(1) and 108(2).

The first and second guides 128(1) and 128(2) may be arranged in-line 130 with the first and second pivots 114(1) and 114(2). For example, axles of the first and second guides 128(1) and 128(2) may be arranged vertically with axles of the first and second pivots 114(1) and 114(2). In one example, the first and second guides 128(1) and 128(2) may be spaced a distance of at least about 2 inches to at most about 8 inches from the first and second pivots 114(1) and 114(2), respectively. In another example, the first and second guides 128(1) and 128(2) may be spaced a distance about 5.5 inches from the first and second pivots 114(1) and 114(2), respectively. While FIG. 1 illustrates the first and second guides 128(1) and 128(2) comprising first and second sheaves, the first and second guides 128(1) and 128(2) may additionally or alternatively comprise sprockets, gears, wear surfaces, or any other structure suitable to guide the lifting member 120. In still other embodiments, the guides may be omitted entirely. When present, the first and second guides 128(1) and 128(2) may comprise a 1.5 inch diameter sheave with a 0.5 inch bushing. A boss or tab may be spaced behind the 1.5 inch diameter sheave to guide the linkage 126.

The first and second guides 128(1) and 1282) may guide the coupling member 122 to lift the received rear portion of the snowmobile in a substantially vertical motion. For example, the first and second guides 128(1) and 128(2) may guide the coupling member 122 to lift the received rear portion of the snowmobile a distance from the bottom 106 of the support member 102 substantially straight up, between the symmetrically facing surfaces 110 of the first and second side supports 108(1) and 108(2). Because the coupling member 122 lifts the received rear portion of the snowmobile in a substantially vertical motion, the snowmobile stand 100 enables a user to lift the snowmobile in confined spaces (e.g., in a snowmobile trailer). For example, because the snowmobile is lifted straight up a user can operate the snowmobile stand 100 between the rear portion of the snowmobile and a wall (e.g., a wall of a snowmobile trailer, a wall of a garage, or a wall of a shop).

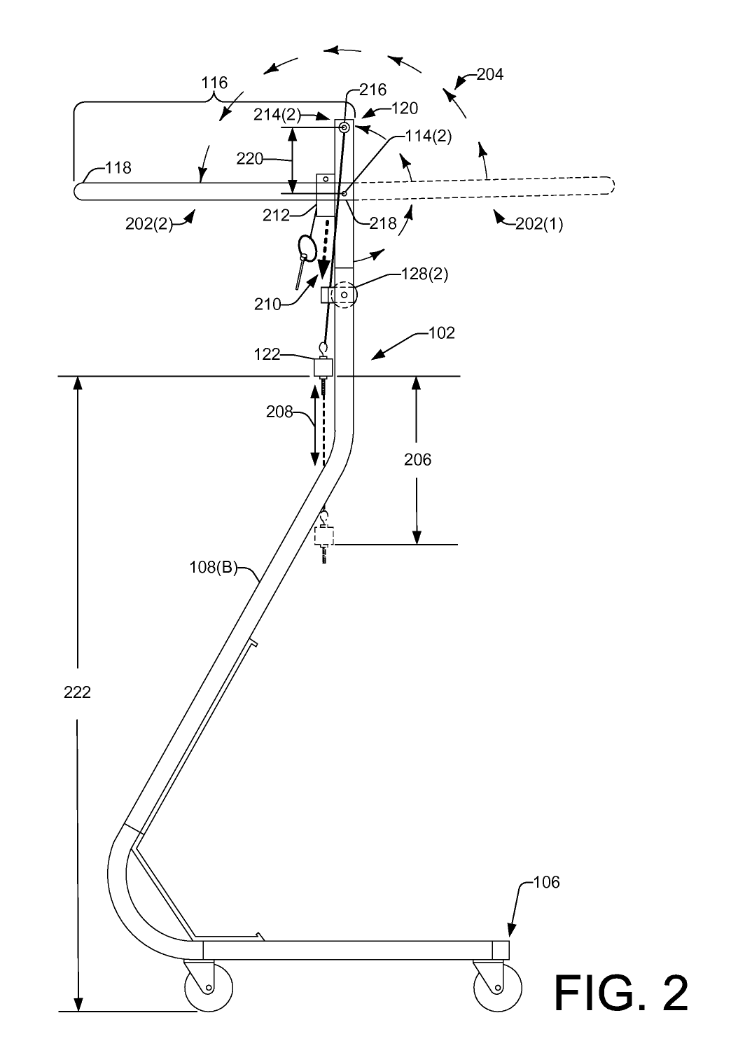

The snowmobile stand may stay in the raised position due to an over center position of the lever mechanism in the raised position (described in more detail with reference to FIG. 2). The snowmobile stand may include a locking member 132 to lock the lever mechanism 116 and prevent the lever mechanism 116 from pivoting. In one example, the locking member 132 may lock the gripping portion 118 in a position where the gripping portion 118 is arranged behind the support member 102. While FIG. 1 illustrates the locking member 132 comprising a pin 134 and a socket 136, the locking member 132 may comprise a latch, a strap, an interference fit, a clamp, or any other mechanism to lock the lever mechanism 116 and prevent the lever mechanism 116 from pivoting. The locking member 132 may enable a user to safely operate a lifted snowmobile. For example, the locking member 132 may enable a user to run the engine and turn or rotate a track of a lifted snowmobile.

FIG. 2 illustrates a side view of the example snowmobile stand 100 shown in FIG. 1 including the lever mechanism 116 having the gripping portion 118 displaceable between a first position 202(1) and a second position 202(2). The gripping portion 118 may be coupled to a first end of the lever mechanism 116. The lifting member 120 may be coupled to a second end of the lever mechanism 116, and the lever mechanism 116 may pivot about the first and second pivots 114(1) and 114(2) pivotably coupled on the symmetrically facing surfaces 110 of the first and second side supports 108(1) and 108(2).

The lever mechanism 116 may pivot about the first and second pivots 114(1) and 114(2) responsive to a displacement 204 of the gripping portion 118 from the first position 202(1) where the gripping portion 118 is arranged in front of the support member 102 to the second position 202(2) where the gripping portion 118 is arranged behind the support member 102. The displacement 204 of the gripping portion 118 from the first position 202(1) to the second position 202(2) may cause the lifting member 120 to be raised a distance 206 from the bottom 106 of the support member 102. For example, the displacement 204 of the gripping portion 118 from the first position 202(1) to the second position 202(2) may cause the lifting member 120 to be raised the distance 206 substantially straight up, between the symmetrically facing surfaces 110 of the first and second side supports 108(1) and 108(2). While FIG. 2 illustrates the raised distance 206 may be about 7 inches, the distance 206 may be adjustable and may be any distance. For example, a user may adjust the raised distance 206 to be at least about 3.0 inches up to at most about 11.0 inches. As discussed above, the first and second guides 128(1) and 128(2) may be arranged in-line 130 with the first and second pivots 114(1) and 114(2) and guide the coupling member 122 in a substantially vertical motion 208. Because the first and second guides 128(1) and 128(2) guide the coupling member 122 straight up in a substantially vertical motion 208, the coupling member 122 lifts the received rear portion of the snowmobile in a substantially vertical motion.

While FIG. 2 illustrates the displacement 204 of the gripping portion 118 from the first position 202(1) to the second position 202(2) being about 180 degrees, the displacement 204 of the gripping portion 118 may be any amount of rotation about the first second pivots 114(1) and 114(2). For example, the displacement 204 of the gripping portion 118 from the first position 202(1) to the second position 202(2) may comprise at least about 90 degrees to at most about 270 degrees.

FIG. 2 illustrates that when the gripping portion 118 is in the second position 202(2), the lever mechanism 116 is positioned in an over center position 210 such that a weight of the snowmobile holds the gripping portion 118 in the second position 202(2). For example, when the gripping portion 118 is in the second position 202(2), the weight of the snowmobile resting on the coupling member 122 applies a force on the lever mechanism 116 in a downward direction to hold the gripping portion 118 in the second position 202(2). In one example, the weight of the snowmobile may force the lever mechanism 116 down on a cross member 212 or other stop of the snowmobile stand 100. The cross member 212 may be fixed to the top 104 of the support member 102. For example, the cross member 212 may be fixed to each of the first and second side supports 108(1) and 108(2) at the top 104 of the support member 102.

The lever mechanism 116 may include first and second protruding members 214(1) and 214(2) arranged at ends of the lever mechanism 116 opposite the gripping portion 118 of the lever mechanism 116. The raised distance 206 may be adjusted by adjusting a length of the protruding members 214(1) and 214(2). Each of the first and second protruding members 214(1) and 214(2) may have a free end 216 opposite a fixed end 218. Each free end 216 may be arranged a distance 220 away from the first and second pivots 114(1) and 114(2) pivotably coupled to the first and second side supports 108(1) and 108(2). While FIG. 2 illustrates the distance 220 being about 3.5 inches, the distance 220 may be any distance. In some examples, the distance 220 may be at least about 1.0 inch or at most about 6.0 inches. Each free end 216 may be arranged the distance 220 away from the first and second pivots 114(1) and 114(2) to provide at least in part a five to one mechanical advantage for lifting the snowmobile in one easy motion. Each fixed end 218 may be arranged adjacent to the first and second pivots 114(1) and 114(2) pivotably coupled in the first and second side supports 108(1) and 108(2).

FIG. 2 illustrates that the displacement 204 of the gripping portion 118 from the first position 202(1) to the second position 202(2) may cause the lifting member 120 to be arranged a distance 222 above the bottom 106 of the support member 102. For example, the displacement 204 of the gripping portion 118 may cause the lifting member 120 to be arranged a distance of about 33.0 inches above the bottom 106 of the support member 102. In another example, the displacement 204 of the gripping portion 118 may cause the lifting member 120 to be arranged a distance of at least about 15.0 inches to at most about 40.0 inches above the bottom 106 of the support member 102. When the gripping portion 118 is in the first position 202(1) the lifting member 120 may be positioned at about 26.0 inches from the bottom 106 of the support member 102.

FIG. 2 illustrates the snowmobile stand 100 may include a height adjustment mechanism. For example the first and second side supports 108(1) and 108(2) may comprise a height adjustment mechanism to adjust a height of the first and second side supports 108(1) and 108(2). In one example, the first and second side supports 108(1) and 108(2) may comprise concentric tubes arranged proximate to the first and second guides 128(1) and 128(2), and/or adjust a length of the linkage 126.

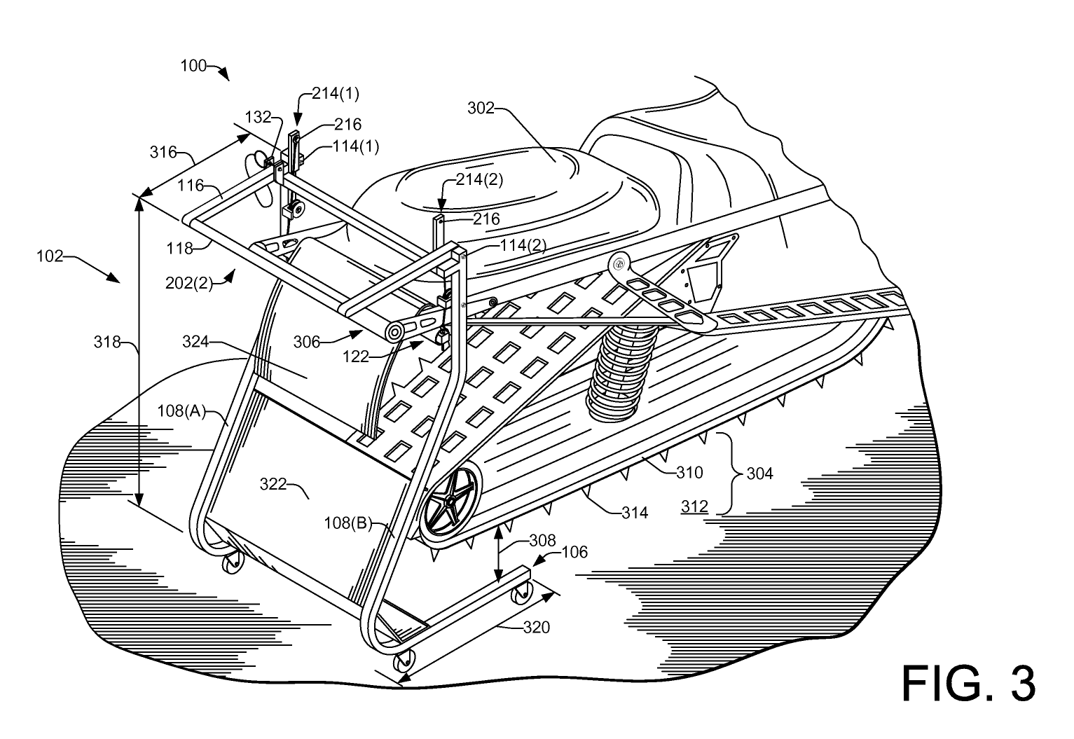

FIG. 3 illustrates a perspective view of the example snowmobile stand 100 shown in FIG. 1 with a snowmobile 302 in a lifted position 304. FIG. 3 illustrates the lever mechanism 116 having been actuated to the second position 202(2), and causing at least a rear portion 306 of the snowmobile 302 to be raised a distance 308 from the bottom 106 of the support member 102. For example, and as discussed above, the lever mechanism 116 may pivot about the first and second pivots 114(1) and 114(2) responsive to a displacement 204 of the gripping portion 118 from the first position 202(1) to the second position 202(2) and cause the coupling member 122 to be raised the distance 206 from the bottom 106 of the support member 102. Responsive to the coupling member 122 being raised the distance 206 from the bottom 106 of the support member 102, the rear portion 306 of the snowmobile 302 may be raised the distance 308 from the bottom 106 of the support member 102. For example, a track 310 of the snowmobile 302 may be raised the distance 308 from the bottom 106 of the support member 102. Moreover, responsive to the coupling member 122 being raised the distance 206 from the bottom 106 of the support member 102, the entire track 310 may be raised off of the ground 312. In one example, the distance 308 the track 310 is raised may be about the same as the distance 206 the coupling member 122 is raised. In another example, the distance 308 the track 310 is raised may be less than the distance 206 the coupling member 122 is raised. In some examples, the entire track 310 may be raised off of the ground 312 to prevent paddles 314 of the track 310 from being damaged and/or enable a user to safely operate the raised track 310. For example, the snowmobile 302 may be a mountain snowmobile that has longer paddles 314 on the track 310 that need to be protected from being bent or deformed out of shape when the snowmobile is parked to maintain the shape of the paddles 314 for maximum propulsion.

The lever mechanism 116 may have a length 316 of about 14.0 inches to provide at least in part the five to one mechanical advantage for lifting the snowmobile in one easy motion. For example, the length 316 of the lever mechanism 116, and the distance 220 each of the free ends 216 of the first and second protruding members 214(1) and 214(2) are away from the first and second pivots 114(1) and 114(2) may together provide the five to one mechanical advantage for lifting the snowmobile in one easy motion. Because the lever mechanism 116 has the length 316 of about 14.0 inches, this enables a user to lift a track of a snowmobile in confined spaces. For example, because of the compact arrangement of the lever mechanism 116 pivotably coupled to the top 104 of the support member 102, a user sandwiched between a wall and the rear portion of the snowmobile can easily displace the gripping portion 118 from the first position 202(1) to the second position 202(2) to lift the track 310 of the snowmobile 302 straight up. However, in other examples, the length of lever 116 may be more or less than 14.0 inches and may achieve a mechanical advantage more or less than five to one.

The snowmobile stand 100 may have a height 318 of about 42.0 inches and a length 320 of about 20.0 inches. The first and second pivots 114(1) and 114(2) may be arranged proximate to a middle of the length 320 of the bottom 106 of the support member 102. For example, the first and second pivots 114(1) and 114(2) may be arranged at about 9.0 inches in towards the middle of the support member 102. Moreover, the first and second guides 128(1) and 128(2) may be fixed to the first and second side supports 108(1) and 108(2) at about 85% of the height 318 of the snowmobile stand 100. For example, the first and second guides 128(1) and 128(2) may be arranged at about 36.0 inches above the bottom 106 of the support member 102. The snowmobile 302 may include a shield 322 to prevent debris (e.g., snow, ice, and/or racing studs mounted in the track) from being thrown out away from the track 310 of the snowmobile 302. The compact height 318 and length 320 may provide for positioning the snowmobile stand 100 behind the snowmobile 302 in a confined space. For example, the snowmobile stand 100 may be positioned between a wall of a snowmobile trailer and the rear of the snowmobile parked in the snowmobile trailer to lift the track 310 of the snowmobile 302. The snowmobile stand 100 may be formed of metal, plastic, composite, or combination of metal (e.g., Aluminum, steel, etc.,), plastic and/or composite. In one example, the snowmobile stand 100 may be formed of Aluminum tubing. The snowmobile stand 100 may be formed of round tubing, rectangular tubing, oval tubing, etc.

FIG. 3 illustrates the coupling member 122 may be removeably coupled under the received rear portion 306 of the snowmobile 302 between the track 310 of the snowmobile 302 and the received rear portion 306 of the snowmobile 302. The coupling member 122 may removeably couple in front of a snow flap 324 of the snowmobile 302. Because the coupling member 122 removeably couples in front of the snow flap 324 the coupling member 122 does not interfere with the snow flap 324, and prevents the snow flap 324 from being damaged (e.g., bent, deformed, twisted, cracked, etc.). Preventing the snow flap 324 from being damaged provides for proper cooling of the snowmobile. For example, because the coupling member 122 removeably couples in front of the snow flap 324, the snow flap 324 does not deform up and under the received rear portion 306 of the snowmobile, which prevents snow from coming in contact with, and cooling, a cooling system arranged up and under the received rear portion 306 of the snowmobile 302. Moreover, because the coupling member 122 removeably couples in front of the snow flap 324 and under the received rear portion 306 of the snowmobile 302 between the track 310 of the snowmobile 302 and the received rear portion 306 of the snowmobile 302, the snowmobile stand 100 does not interfere or damage the snowmobile 302. For example, the snowmobile stand 100 does not damage expensive graphics and/or components (e.g., carbon fiber and/or plastic bumper covers) of the snowmobile 302.

FIG. 3 illustrates the locking member 132 in a locked position. The locking member 132 locks the lever mechanism 116 and prevents the lever mechanism 116 from pivoting inadvertently. For example, FIG. 3 illustrates the pin 134 removeably received in the socket 136 and locking the gripping portion 118 in a position where the gripping portion 118 is arranged behind the support member 102. Because the locking member 132 is in the locked position, a user may safely operate the lifted snowmobile 302.

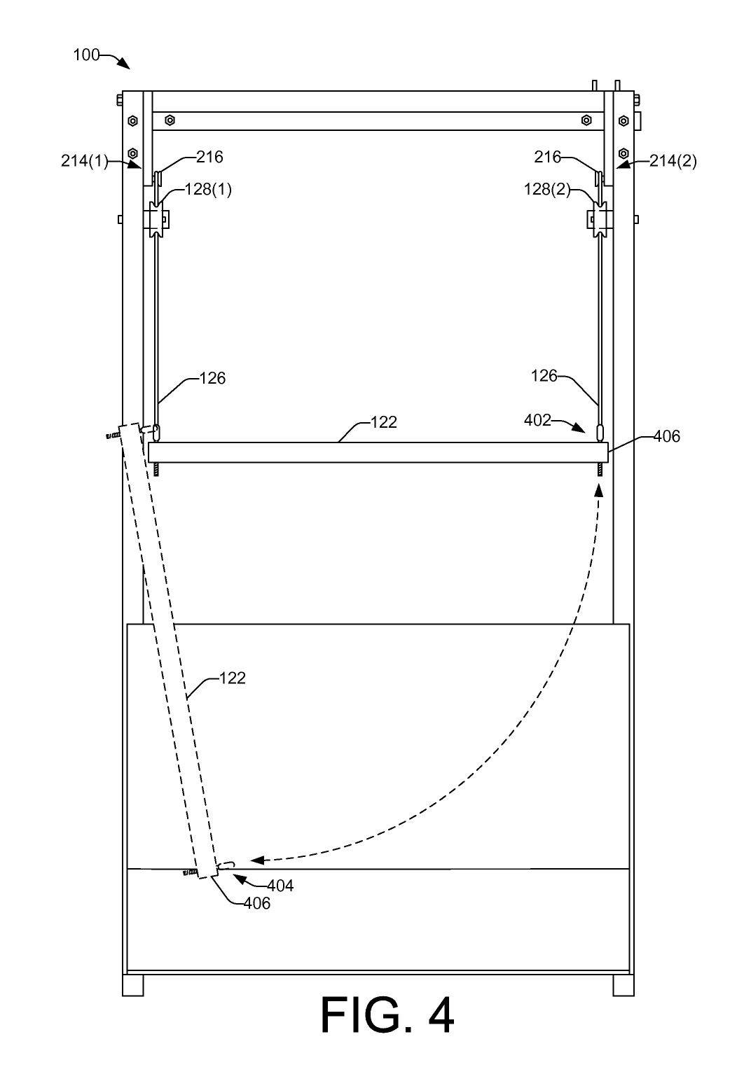

FIG. 4 illustrates a back view of the example snowmobile stand 100 shown in FIG. 1 having the coupling member 122 selectively movable between a latched position 402 and an unlatched position 404. For example, FIG. 4 illustrates the coupling member 122 may be movable to the unlatched position 404 for positioning under the received rear portion 306 of the snowmobile 302 between the track 310 of the snowmobile 302 and the received rear portion 306 of the snowmobile 302, and is movable to the latched position 402 to lift the received rear portion 306 of the snowmobile 302. For example, a user may disconnect ends 406 of the coupling member 122 from a portion of the linkage 126. For example, a user may disconnect the end 406 of the coupling member 122 from an end of a flexible cable, an end of a rigid link, an end of a chain, an end of a belt, etc. for positioning the coupling member under the received rear portion 306 of the snowmobile 302 between the track 310 of the snowmobile 302 and the received rear portion 306 of the snowmobile 302. Further, the coupling member 122 may be movable to the unlatched position 404 for positioning in front of the snow flap 324 of the snowmobile 302.

In another example, a user may connect the ends 406 of the coupling member 122 to a portion of the linkage 126. For example, a user may connect the end 406 of the coupling member 122 to an end of a flexible cable, an end of a rigid link, an end of a chain, an end of a belt, etc. to lift the received rear portion 306 of the snowmobile 302. The ends 406 of the coupling member 122 may connect to a portion of the linkage via a hook, a clasp, a cap, a strap, etc. In one example, an eye bolt and/or a j-bolt may be fastened to the end 406 of the coupling member 122 and arranged to connect to an end loop in a flexible cable. In another example, the ends 406 of the coupling member 122 may be bolts and hooks arranged to be adjustable to fit a variety of lift heights and connect to a portion of the linkage. While FIG. 3 shows one end 406 of the coupling member 122 selectively movable between a latched position 402 and an unlatched position 404, both ends may be movable between the latched position 402 and the unlatched position 404. For example, the other end of the coupling member 122 may be disconnected and/or connected to an end of the linkage 126 and moved between the latched position 402 and the unlatched position 404. The coupling member 122 allows a user to easily disconnected on one side so the coupling member 122 can be easily placed under the received rear portion 306 (e.g., a bumper or track tunnel) of the snowmobile and reconnected on the other side. In this way, a user does not have to physically grasp the snowmobile and lift the snowmobile and place the snowmobile on a portion of a lifting rack. Moreover, because a user does not have to physically grasp the snowmobile and lift the snowmobile a user is prevented from smashing the fingers and/or hands of the user.

### CONCLUSION

Although the invention has been described in language specific to structural features and/or methodological acts, it is to be understood that the invention is not necessarily limited to the specific features or acts described. Rather, the specific features and acts are disclosed as illustrative forms of implementing the invention. For example, while embodiments are described having certain shapes, sizes, and configurations, these shapes, sizes, and configurations are merely illustrative.

What is claimed is:

1. A snowmobile stand comprising:
a first side support and a second side support, the first and second side supports being spaced a distance apart to receive at least a rear portion of a snowmobile between the first and second side supports; and
a lifting member disposed between and coupled to the first and second side supports, the lifting member comprising a coupling member selectively movable between a latched position and an unlatched position,
wherein the coupling member is movable to the unlatched position for positioning under the received rear portion of the snowmobile between a track of the snowmobile and the received rear portion of the snowmobile, and is movable to the latched position to lift the received rear portion of the snowmobile.

2. The snowmobile stand of claim 1, wherein the coupling member is further movable to the unlatched position for positioning in front of a snow flap of the snowmobile.

3. The snowmobile stand of claim 1, further comprising a lever mechanism including a gripping portion arranged opposite a first pivot pivotably coupled in the first side support and a second pivot pivotably coupled in the second side support, the lever mechanism coupling the lifting member to the first and second side supports and the lever mechanism to cause the coupling member to lift the received rear portion of the snowmobile.

4. The snowmobile stand of claim 3, wherein the lever mechanism causes the coupling member to lift the received rear portion of the snowmobile in a substantially vertical motion.

5. The snowmobile stand of claim 3, further comprising a linkage coupling the lifting member to the lever mechanism.

6. The snowmobile stand of claim 5, wherein the linkage comprises a cable.

7. The snowmobile stand of claim 3, wherein the lever mechanism further comprises:
first and second protruding members arranged at ends of the lever mechanism opposite the gripping portion of the lever mechanism,
the first protruding member having a free end opposite a fixed end, the free end arranged a distance away from the first pivot pivotably coupled in the first side support, and the fixed end arranged adjacent to the first pivot pivotably coupled in the first side support, and
the second protruding member having a free end opposite a fixed end, the free end arranged a distance away from the second pivot pivotably coupled in the second side support, and the fixed end arranged adjacent to the second pivot pivotably coupled in the second side support.

8. The snowmobile stand of claim 1, further comprising a first sheave fixed to the first side support, and in-line with, the first pivot pivotably coupled in the first side support, and a second sheave fixed to the second side support below, and in-line with, the second pivot pivotably coupled in the second side support, wherein the first and second sheaves guide the coupling member to lift the received rear portion of the snowmobile in a substantially vertical motion.

9. A snowmobile stand system comprising:
a support member having a top opposite a bottom, the support member comprising:
a first side support and a second side support, each of the first and second side supports having a symmetrically facing surface separated by a distance to receive at least a rear portion of a snowmobile between the symmetrically facing surfaces;
a first pivot pivotably coupled on the symmetrically facing surface of the first side support at the top of the support member;
a second pivot pivotably coupled on the symmetrically facing surface of the second side support at the top of the support member; and
a lever mechanism pivotably coupled to the first and second pivots pivotably coupled on the symmetrically facing surfaces of the first and second side supports, wherein when actuated the lever mechanism causes at least the rear portion of the snowmobile to be raised a distance from the bottom of the support member, between the symmetrically facing surfaces of the first and second side supports.

10. The snowmobile stand system of claim 9, further comprising a lifting member disposed between the symmetrically facing surfaces of the first and second side supports, the lifting member to removeably couple under the received rear portion of the snowmobile between a track of the snowmobile and the received rear portion of the snowmobile to raise the received rear portion of the snowmobile the distance from the bottom of the support member, between the symmetrically facing surfaces of the first and second side supports.

11. The snowmobile stand system of claim 10, wherein the lifting member further removeably couples in front of a snow flap of the snowmobile.

12. The snowmobile stand system of claim 10, further comprising a first guide fixed to the symmetrically facing surface of the first side support below the first pivot pivotably coupled on the symmetrically facing surface of the first side support at the top of the support member; and
a second guide fixed to the symmetrically facing surface of the second side support below the second pivot pivotably coupled on the symmetrically facing surface of the second side support at the top of the support member,
wherein the first and second guides guide the lifting member to lift the received rear portion of the snowmobile the distance from the bottom of the support member straight up, between the symmetrically facing surfaces of the first and second side supports.

13. The snowmobile stand system of claim 10, further comprising a linkage coupling the lifting member to the lever mechanism.

14. The snowmobile stand system of claim 13, wherein the linkage comprises flexible cables or rigid links.

15. A snowmobile lifting system comprising:
a support member having a top opposite a bottom; and
a lifting mechanism comprising:
a lever coupled to the support member by at least one pivot; and
a gripping portion coupled to a first end of the lever; and
a lifting member to engage at least a portion of a snowmobile, the lifting member coupled to a second end of the lever,
wherein the lever is pivotable about the pivot, responsive to a displacement of the gripping portion from a first position where the gripping portion is arranged in front of the support member to a second position where the gripping portion is arranged behind the support member, to cause the lifting member to be raised a distance from the bottom of the support member.

16. The snowmobile lifting system of claim 15, wherein the displacement of the gripping portion from the first position to the second position comprises at least about 90 degrees to at most about 270 degrees.

17. The snowmobile lifting system of claim 15, wherein the displacement of the gripping portion from the first position to the second position comprises about 180 degrees.

18. The snowmobile lifting system of claim 15, wherein when the gripping portion is displaced from the first position to the second position, the lifting member raises the portion of the snowmobile the distance from the bottom of the support member in a substantially vertical motion.

19. The snowmobile lifting system of claim 15, wherein when the gripping portion is in the second position, the lever is positioned in an over center position such that a weight of the snowmobile holds the gripping portion in the second position.

20. The snowmobile lifting system of claim 15, further comprising a locking member to lock the gripping portion in the second position.
